(19) United States
(12) Patent Application Publication
(10) Pub. No.: US 2010/0035213 A1
(43) Pub. Date: Feb. 11, 2010

(54) Dental Kit and Method for Retracting Sulcus

(75) Inventors: Dierk Lubbers, Eichberg (CH); Stephan Lampl, Luechingen (CH); Ralf Kollefrath, Ruethi (CH)

Correspondence Address: KATTEN MUCHIN ROSENMAN LLP, 575 MADISON AVENUE, NEW YORK, NY, 10022-2585, US

(73) Assignee: COLTENE WHALEDENT AG, Altstatten (CH)

(21) Appl. No.: 12/535,979

(22) Filed: Aug. 5, 2009

Related U.S. Application Data
(63) Continuation of application No. 11/546,754, filed on Oct. 10, 2006.
Application No. 11/546,754 is a continuation of application No. PCT/CH2003/000798, filed on Dec. 2, 2003.

(30) Foreign Application Priority Data
Mar. 19, 2003 (EP) 03006052.9

(51) Int. Cl. A61C 5/00

(52) U.S. Cl. 433/217.1

(57) ABSTRACT

Sulcus is retracted from teeth prior to performing a dental procedure on the teeth by applying an expandable curable silicone compound to the surface of the teeth and preventing the silicone compound from expanding in a direction away from the surface of the teeth, thereby forcing the silicone to expand against the sulcus and forcing retraction of the sulcus from contact with the teeth.

This application is a continuation of U.S. patent application Ser. No. 11/546,754, filed on Oct. 10, 2006, which is a continuation of International Application No. PCT/CH2003/000798, filed Dec. 2, 2003, which claims priority to European Patent Application Number 03006052.9 filed on Mar. 19, 2003, the contents of which are herein wholly incorporated by reference.

The invention concerns a method for retracting an area at the neck of a tooth during the preparation of a dental impression.

For a preparation of a dental prosthesis, especially dentures covering only a few teeth, an impression of the teeth and the part of the jaw adjacent to these teeth must be provided to the dental technician. Therefore, a molding of the dental situation has to be prepared by the dentist. In order to cover the transition from the tooth to the jaw it is necessary to free the neck of the tooth which is covered by the gingiva. Thus for preparing the dental impression this area the sulcus must be exposed.

Beside a widely used method which relies on the insertion of a retraction cord in the area of the sulcus, U.S. Pat. No. 5,676,543 describes another way. According to the patent specification a mold of the dental situation is prepared by a curable molding mass. The cured impression is subsequently removed. Inside the mold a layer of a syringable and curable material is applied and the thus prepared mold is placed in the mouth again. The syringable and curable material must contain a hemostatic compound or a substance causing tissue retraction. By exerting pressure on the mold this curable material is pressed in the area between the neck of the tooth and the gingiva. By the hemostatic compound a tissue contraction is caused. The sulcus retracts from the neck of the tooth. After cleaning a proper mold of the dental situation including the uncovered sulcus can be made.

It has admittedly been shown that the application of the syringable, curable material into the negative dental impression does not always lead to the required results. In part during the rearrangement of the mold a part of the syringable material is smeared so that a correct sulcus retraction is no longer guaranteed. Finally, the contraction of the sulcus by the hemostatic compound is not always sufficient in order to guarantee the quality of the mold. Further, the quantitative application of the syringable material proves to be difficult since during application the contours of the negative mold are covered and thus control of the layer thickness is no longer possible.

An object of the invention is to avoid the disadvantages of the known techniques and especially to provide an alternative method for uncovering the neck of a tooth.

This is solved by the method according to the claims.

The method according to the invention comprises a number of steps. First a dental impression using a curable compound is made which is removed after being curing. In the area adjacent to the tooth and gingiva a silicone material is applied by a suitable tool. The characterising feature of this silicone material is its volume expansion during curing. The dental mold prepared earlier is placed on the teeth again, whereby the mold represents a one-sided barrier for the expansion of the silicone material. The expansion of the silicone is only possible in the direction toward the sulcus so that the sulcus is detached from the neck of the tooth. The sulcus is detached from the neck of the tooth and not only retracted by the tissue contraction from the neck of the tooth.

There are different systems of materials known which are suitable for a preparation of a dental impression. Usually these systems consist of at least one silicone compound and a catalyst for curing the compound. Preferably, silicone compounds crosslinkable by addition and condensation reactions are used. Both components for the mold can either be provided separately and not mixed until the application or they may form a mixture which is cured by humidity or the like.

The silicone material which expands during curing can consist of barely one silicone compound or a mixture of different silicone compounds. Preferably this expanding silicone material has a minimum expansion of at least 20%, more preferred at least 35% and most preferred at least 70% relative to the original volume. The values of this volume expansion is related to the expansion of the material in a non-limited, i.e. in an open volume. The term expanding is within the scope of the invention such to be understood in that the volume expansion occurs during or after the curing reaction of the silicone material or the mixture of several silicone compounds. Curing reactions are to be understood as reaction processes which lead to the generation of new inter- or intramolecular bonds. The expansion usually will start after the beginning of these reaction processes and will last beyond the end of these reactions.

Suitable silicone compounds which exhibit such an expansion behaviour are silicone compounds crosslinkable by addition reactions. An expanding silicone material exhibiting the above mentioned expansion volume allows an improved and simpler control of the sulcus retraction.

Where appropriate prior to the application of the silicone material a curing catalyst is added or the silicone material already includes a catalyst which initiates the curing due to the existing humidity. In addition to the specific expansion behavior a control can also be achieved due to the amount applied. Both factors thus mutually influence the resulting retraction. Advantageous is an expandable, addition crosslinkable silicone material which is used as a two component system. The different functionalised poly(dimethyl)siloxanes, for example dihydroxy- or divinyl-poly(dimethyl)siloxanes used as essential constituents of these two components comprise a viscosity preferably between 5 and 100 Pa·s. Both components additionally comprise fillers which commonly are used for dental masses. These fillers may either be surface treated or be without any surface treatment. Examples for fillers are silica, pyrogeneous silica, calcium carbonate, milled quartz or silicates.

The use of silicone materials crosslinkable by addition reactions avoids possible adverse effects to the health of the patients since during curing no harmful compounds are released, i.e. are cleaved. Further, these type of compounds are advantageous by the fact that they do not react with the molding material. After curing the expanded silicone can be removed either in one piece or in a few pieces from the area of the tooth. At the same time there exists a possibility for the dentist to control the result of the retraction, where required to apply again expanding silicone material to the area insufficiently uncovered and to repeat the retraction step. The procedure is not possible with a silicone compound which permanently bonds to the mold. In this case a complete repetition of the whole procedure is necessary.

The method is further advantageous if prior to the application of the expanding silicone material to the area adjacent between the tooth and the gingiva at least one hemostatic compound or an astringent is applied. Examples of hemostatic compounds or astringents are—including the different, suitable hydrates—potassium aluminum sulfate, aluminum sulfate, aluminum iron sulfate, aluminum ammonium sulfate, iron chloride, aluminum chloride, sodium chloride, zinc chloride, zinc phenol sulfate, tannic acids, adrenalin or other known compounds. By applying these compounds bleeding caused by the expansion of the silicone material can immediately be stopped. Thus, after the removal of the cured and expanded silicone the displaced sulcus can easily be cleaned from leaked liquids and remains widely free of further leaking of liquids for a subsequent final molding of the dental situation. Since a chemical compatibility of the hemostatic compound with the expanding silicone can not be guaranteed at all times, both components have therefore to be applied separately. But single hemostatic compounds like tannic acids can be incorporated into the addition crosslinkable, expanding silicone material, so that a common application to the area between tooth and gingiva is possible.

The method is additionally advantageous if the replaced dental impression, that means the molding is kept in its position by the opposite lying row of teeth. The patient can achieve this by a simple biting. A cumbersome and error causing holding of the mold by the dentist can be avoided. Due to the fixing by the opposite laying teeth an uniform retraction of the sulcus can be achieved.

Another embodiment of the above mentioned method uses pieces of rolls, especially cotton rolls instead of a dental impression which has to be prepared prior to the retraction step. These rolls may be formed as cylindrical bodies but other shapes are also suitable. For example Comprecap™ rolls can be used. The rolls are arranged to the area where the sulcus has to be exposed after the expandable silicone material has been applied. The cotton rolls act similar as the dental impression as a barrier for the expansion of the expandable silicone material.

In a further embodiment the cured expanded silicone material is removed with the help of a cord, i.e. a retraction cord which has been embedded in the expandable silicone material after the application of the silicone material. The cord is fixed within the silicone material during the curing process. The cord may also be placed in the area between the neck of the tooth and the gingiva prior to the application of the expandable silicone material and is then covered by the silicone material during the application. As cords all materials suitable for dental application can be used.

In still another embodiment of the invention the dental impression is prepared from a molding mass crosslinkable by addition reaction. The surface of the impression directing toward the teeth will be not treated with a molding release agent prior to the rearrangement of the mold. Especially in case a addition crosslinkable expandable silicone material is used, this expandable silicone material will permanently bond to the mold. The cured expanded silicone material is then removed together with the mold. This simplifies the procedure of preparing an exposed sulcus.

A further aspect of the invention is a dental kit which can be used for its application in the above discussed method. The kit comprises a curable molding mass, by which a dental impression can be made, and at least one expandable silicone material wherein the volume expansion amounts at least to 20%, preferably at least to 35%, more preferably at least to 50% and most preferably at least to 70% compared to the original volume of the non-cured mixture.

Further advantageously this kit comprises a hemostatic compound analog to these as described above, which have to be applied separately to the area to be treated.

In an other embodiment of the dental kit, the expandable silicone material comprises a hemostatic compound, preferably at least one tannic acid. In this case the mixture of tannic acid and expandable silicone material is applied to the area to be treated.

The invention is explained in more detail by examples and the FIGURE.

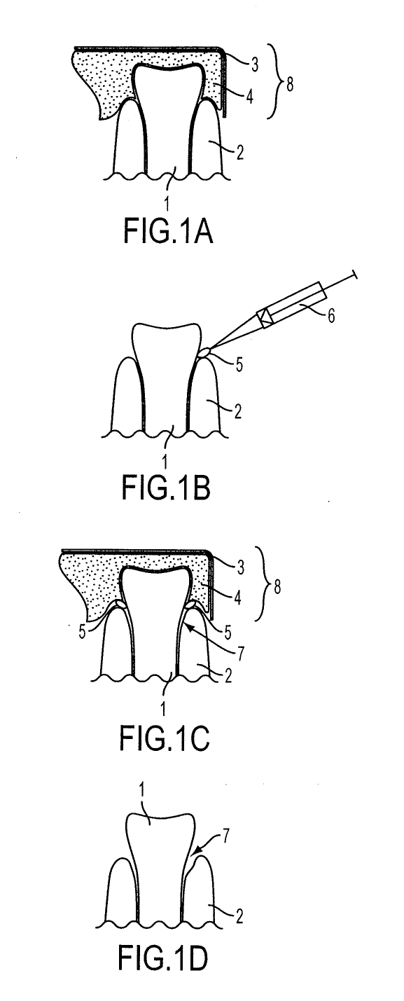

FIGS. 1a to d shows a depiction of essential method steps.

### EXAMPLE 1

The sequence of steps for the sulcus retraction starts with the preparation of the dental impression as it is shown in FIG. 1a. The tooth 1 as well as the adjacent gingiva is enfolded by the molding mass 3. As molding mass a condension crosslinkable rubber mastic SPEEDEX PUTTY (Coltène AG) is used which therefore is placed in a molding tool 4. The molding tool 4 is pushed onto the tooth 1 and the adjacent tissue 2, respectively.

After the curing of the molding mass 3 which takes place after ca. 3 to 4 minutes, the mold 8 can be removed and tooth 1 as well as tissue 2 can be cleaned. Prior to applying the expanding silicone compound, brushing of aluminum sulfate as a hemostatic compound to the area takes place. Into the area adjacent between tooth 1 and tissue 2 the expanding silicone compound 5 is applied by an in-situ mixing application tool 6. This expanding silicone compound consists of two components A and B.

Component A consists of:

| | |
|---|---|
| 10 g | alpha, omega-dihydroxy-polydimethylsiloxan (viscosity |
| | 18 Pa · s: Wacker Silicone) |
| 5 g | milled quartz SIKRON B600 (Quarzwerke Frechen, D) |
| 0.05 g | SILOPREN U-Katalysator Pt/D (GE Bayer Silicones) |
| 0.02 g | Divinyltetramethyldisiloxan (Fluka) |

Component B consists of:

| | |
|---|---|
| 9.08 g | alpha, omega-Divinyl-polydimethylsiloxan (viscosity |
| | 20 Pa · s, Wacker Silicones) |
| 5 g | milled quartz SIKRON B600 (Quarzwerke Frechen, D) |
| 0.3 g | Polymethylhydrosiloxan (viscosity 20 mPa · s; |
| | Wacker Silicones) |

Both components A and B are homogeneously mixed at a mass ratio of 1:1. Due to the immediate mixing of the silicone components A and B during the application the curing reaction is initiated. The surface of the prepared mold 8 is treated with a mold release agent prior to its rearrangement and the mold is rearranged to the tooth after the application of the expanding silicone compound (FIG. 1c). Thus, the expansion of the homogeneous mixture of the silicone components A and B is limited in its direction of expansion and can only act towards the area of the sulcus 7. The separated application of aluminum sulfate and the mixture is necessary due to the incompatibility of the components.

After the expansion of the mixture 5 of the silicone components has taken place the mold 8 is removed. The expanded mixture 5 of the silicone components remains separated from the mold 8 at tooth 1 and can be removed as few connected pieces from the now expanded area 7 of the sulcus. The final molding of the dental situation can be performed with high accuracy after cleaning of the expanded area of the sulcus. FIG. 1d shows tooth 1 with the uncovered sulcus 7 and the gingiva 2 laying below.

In case of an insufficient uncovering of the sulcus the method steps as shown schematic in FIGS. 1b and 1c can be repeated.

### EXAMPLE 2

According to the second example the dental impression is made by an addition crosslinkable impression material AFFINIS PUTTY (Coltène AG). The impression material is therefore placed in the molding tool and the tool is arranged on the dentition. After curing of the material the mold is removed and a molding release agent GI MASK SEPARATOR (Coltène AG) is applied after a cleaning step. Due to the mold release agent the mold and the cured, expanded silicone compound can be removed separately of each other.

The further steps for the sulcus retraction follows the steps as described for the example above.

The final molding of the dental situation can be performed by the commonly available molding masses.

### EXAMPLE 3

Different to the preparation of the mold as described in example 2 the mold was not treated with a molding release agent prior to the rearrangement on the teeth. The cured, expanded silicone compound is permanently bonded to the mold and is removed as one piece together with the mold.

### EXAMPLE 4

Instead of preparing a dental impression the limitation of the expansion direction of the expandable silicone component mixture 5 is achieved by Comprecap™ cylinder (Coltène Whaledent/Roeko). The silicone component mixture 5 is identical to the one described in example 1. The required number of Comprecaps is placed in stable orientations at the area where the sulcus has to be removed from the neck of the tooth. The Comprecaps cover the surface of the applied expandable silicone material which is not in contact with the tooth or the gingiva tissue, i.e. the surface which directs away from the tooth and gingiva. After curing and the simultaneously occurring expansion of the silicone material, the cured silicone material is removed together with the Comprecaps™. The final dental impression can be prepared after cleaning the treated area similar as described in example 1.

### EXAMPLE 5

In a modified method of example 1 a retraction cord Retracto™ (Coltène Whaledent/Roeko) is embedded in the mixture 5 after the application of the expandable silicone material 5. Due to this retraction cord the cured silicone material is easily removable.

1-23. (canceled)

24. A method for retracting the sulcus at the boundary of a tooth in the mouth of a patient, comprising the steps of:
(i) molding a dental impression of a portion of the patients mouth including said tooth, with a curable composition;
(ii) removing the cured mold:
(iii) applying an expanding silicone material which expands upon curing, to the adjacent area between the tooth and gingiva and,
(iv) reapplying the mold to the mouth of the patient to form a barrier to the expansion of the silicone material to limit the expansion of the silicon only in the direction toward the sulcus whereby the sulcus is detached from the neck of the tooth as the material expands.

25. The method according to claim 24, wherein the silicone material is selected from silicone materials that expand at least 20% during curing.

26. The method according to claim 25, wherein the silicone material expands at least 30%.

27. The method according to claim 24, wherein at least one hemostatic compound is applied to the area adjacent the tooth and gingiva prior to the application of the expanding silicone material.

28. The method according to claim 24, wherein the mold is prepared such that the mold is capable of being held in place by the opposing row of teeth.

29. The method according to claim 24, wherein a curable molding mass consists of a system of at least one silicone compound and a catalyst for initiating the curing reaction.

30. The method according to claim 24, wherein the expanding silicone material comprises at least one silicone compound cross linkable by an addition reaction.

31. The method according to claim 27, wherein the hemostatic compound is selected from the group consisting of potassium aluminum sulfate, aluminum sulfate, aluminum iron sulfate, aluminum ammonium sulfate, iron chloride, aluminum, sodium chloride, zinc chloride, zinc phenol sulfate, tannic acids, adrenalin and mixtures thereof.

32. The method according to claim 27, wherein the hemostatic compound is at least tannic acid.

33. The method according to claim 24 and further comprising the step of applying a molding release agent to the mold after it is cured and before reapplying the mold to the mouth, whereby the mold can thereafter be removed from the mouth without removal of the expanding silicone material.

34. The method according to claim 24 and wherein the mold is free of a molding release agent whereby the expanding silicone is extractable from the mouth together with removal of the mold from the mouth.
